(19) United States
(12) Patent Application Publication
(10) Pub. No.: US 2025/0053610 A1
(43) Pub. Date: Feb. 13, 2025

(54) SIMULATION APPARATUS AND SIMULATION METHOD

(71) Applicant: Hitachi, Ltd., Tokyo (JP)

(72) Inventor: Yusuke SUGITA, Tokyo (JP)

(21) Appl. No.: 18/594,072

(22) Filed: Mar. 4, 2024

(30) Foreign Application Priority Data
Aug. 10, 2023 (JP) 2023-130994

(51) Int. Cl. G06F 17/11

(52) U.S. Cl. CPC G06F 17/11

(57) ABSTRACT

A simulation apparatus is an apparatus that obtains a solution of a combinatorial optimization problem by SA, in which a local optimal solution of an objective function is acquired by using a local search method of changing a temperature parameter, a statistic is calculated based on the local optimal solution and a probability distribution function of a variable included in the objective function, a maximum value (temperature parameter when a standard deviation related to a state of the local optimal solution is large) and a minimum value (temperature parameter when the standard deviation is small) as a search range for the temperature parameter are obtained based on the calculated statistic (standard deviation), and a good solution is obtained by executing the simulated annealing a plurality of times in the search range having the maximum value and the minimum value for the temperature parameter.

### CROSS-REFERENCE TO RELATED APPLICATION

The present application claims priority from Japanese application JP2023-130994, filed on Aug. 10, 2023, the content of which is hereby incorporated by reference into this application.

### BACKGROUND OF THE INVENTION

### 1. Field of the Invention

The present invention relates to a simulation apparatus and a simulation method, and particularly to a simulation apparatus and a simulation method suitable for use in setting a temperature parameter when solving a combinatorial optimization problem by a method using simulated annealing.

### 2. Description of Related Art

Various physical phenomena and social phenomena can be expressed using an interaction model. The interaction model is defined by a plurality of nodes constituting the model, a nonlinear coefficient (interaction coefficient) between the nodes, and if necessary, a linear coefficient (bias coefficient or external magnetic field coefficient) acting on each node. In the fields of physics and social science, various models including an Ising model have been proposed, and all of them can be interpreted as one form of the interaction model.

The calculation of a node state which minimizes the energy of the interaction model (referred to as a ground state) can be applied to solving a combinatorial optimization problem. Examples of the combinatorial optimization problem include a problem of detecting cliques in social networks and a portfolio optimization problem in the financial field. In the field of operations research, these problems are roughly classified into quadratic unconstrained binary optimization problems and mixed binary quadratic programming problems (mix of integers and real numbers in variables).

As an algorithm for solving a ground state search problem of the interaction model, there is simulated annealing (hereinafter also abbreviated as “SA”). The simulated annealing is a stochastic optimization method by gradually reducing randomness of a state update by likening to annealing as a physical phenomenon (for example, a method of heating a metal and then gradually cooling the metal to stabilize a form of the metal in metal processing).

In the annealing as a physical phenomenon, a thermal fluctuation is gradually weakened, so that an object converges to a more stable state in terms of energy.

Similarly, in optimization using the simulated annealing, the temperature is used as an external parameter, a high value is set first, and the temperature is gradually lowered as the optimization procedures. At a high temperature, the algorithm stochastically accepts a solution that makes an objective worse than a current solution, so that it is possible to avoid a situation where a global optimal solution is not obtained due to a local optimal solution. In addition, as the temperature is lowered, a probability of the acceptance for the solution that makes the objective function worse decreases, and thus, a search region of solutions is gradually narrowed. This gradual cooling process allows the simulated annealing to effectively find a good solution.

A system for solving the mixed binary quadratic programming problem including the ground state search problem of the Ising model in relation to the simulated annealing is disclosed in, for example, PTL 1. PTL 1 describes a method of efficiently performing a ground state search based on simulated annealing by converting an interaction relationship into a complete bipartite graph structure with respect to the mixed binary programming problem including the ground state search problem of the Ising model.

In addition, for example, PTL 2 discloses another technique of a ground state search of an Ising model based on simulated annealing. PTL 2 describes a method of determining a maximum value of a temperature parameter of simulated annealing for the Ising model by comparing an energy of a state of a local optimal solution with an energy of a state where one spin of the Ising model is flipped from the local optimal solution.

### CITATION LIST

### Patent Literature

PTL 1: WO2021/220445
PTL 2: JP2020-173579A

### SUMMARY OF THE INVENTION

As described above, in the simulated annealing, a hyper parameter for determining a magnitude of the randomness is referred to as a temperature parameter. In order to maximize performance of the simulated annealing, it is necessary to appropriately adjust the randomness, that is, the temperature parameter.

If a temperature parameter range is too wide, a calculation amount required in the process of gradually decreasing the temperature parameter increases, and efficiency of the simulation decreases. On the other hand, if the temperature parameter range is too narrow, it is more likely that the global optimal solution cannot be reached.

PTL 2 discloses a technique in which a temperature correction unit calculates a corrected temperature for simulated annealing based on a maximum value of energy changes between the local optimal solution and the state where one spin is flipped from the local optimal solution (FIG. 10, paragraph [0117], and FIG. 11).

However, although there is description related to a method of calculating an upper limit of the temperature parameter, there is no description related to a method of calculating a lower limit.

Further, there is no description related to a method of obtaining a temperature parameter range for a model including a variable with discrete multiple values or continuous values.

An object of the invention is to provide a simulation apparatus and a simulation method capable of appropriately determining a temperature parameter range for performing a ground state search of an interaction model by simulated annealing, including a case where a variable takes discrete multiple values or continuous values, and efficiently acquiring a good solution.

A configuration of a simulation apparatus according to the invention is a simulation apparatus that solves a certain combinatorial optimization problem by simulated annealing, in which a local optimal solution of the problem is acquired by using a local search method, a statistic is calculated based on the local optimal solutions and a probability distribution function of variables included in an objective function, a maximum value and a minimum value as a search range for the temperature parameter are obtained based on the calculated statistic, and better solutions are efficiently obtained by executing the simulated annealing a plurality of times in the search range having the maximum value and the minimum value for the temperature parameter.

According to the invention, it is possible to provide a simulation apparatus and a simulation method capable of appropriately determining a temperature parameter range for solving a ground state search problem of an interaction model by simulated annealing and efficiently acquiring better solutions.

### BRIEF DESCRIPTION OF THE DRAWINGS

FIG. 1 is a conceptual diagram of an energy landscape of an interaction model;

FIG. 2 is a diagram showing a progress of a solution search when a temperature parameter T is gradually changed in SA;

FIG. 3 is a diagram showing an energy transition between a state corresponding to a local optimal solution of a ground state search problem of an Ising model and a state where a spin is flipped from the state;

FIG. 4 is a diagram showing a state of a discrete probability distribution function of a binary variable corresponding to temperature parameter values;

FIG. 5 is a diagram showing a state of a discrete probability distribution function of a continuous variable corresponding to temperature parameter values;

FIG. 6 is a diagram showing a process of state transitions of SA corresponding to temperature parameter values;

FIG. 7 is a diagram showing a process where a plurality of local optimal solutions are obtained by a local search for acquiring the local optimal solution;

FIG. 8 is a functional configuration diagram of a simulation apparatus;

FIG. 9 is a hardware and software configuration diagram of the simulation apparatus;

FIG. 10 is a flowchart showing a ground state search process;

FIG. 11 is a flowchart showing a process of the SA performed by the simulation apparatus;

FIG. 12 is a data flow diagram in the simulation apparatus; and

FIG. 13 is a diagram showing an example of a simulation result screen.

### DESCRIPTION OF EMBODIMENTS

Hereinafter, embodiments according to the invention will be described with reference to the drawings. The embodiments are examples for describing the invention, and are omitted and simplified as appropriate for clarity of description. The invention can be implemented in various other aspects. Unless otherwise specified, each component may be single or plural.

In order to facilitate understanding of the invention, the position, size, shape, range, and the like of each element shown in the drawings may not represent the actual position, size, shape, range, and the like. Therefore, the invention is not necessarily limited to the position, size, shape, range, and the like disclosed in the drawings.

As examples of various types of information, expressions such as “table”, “list”, and “queue” may be used for description, but the various types of information may be expressed in a data structure other than these described. For example, various types of information such as “XX table”, “XX list”, and “XX queue” may be “XX information”. In describing identification information, when expressions such as “identification information”, “identifier”, “name”, “ID”, and “number” are used, the expressions can be replaced with one another.

When there are a plurality of components having the same or similar functions, the same reference numeral may be assigned with different subscripts. However, when it is not necessary to distinguish the plurality of components, the subscripts may be omitted from the description.

In the embodiment, a process performed by executing a program may be described. Here, a computer executes the program by a processor (for example, a CPU or a GPU) and performs a process determined by the program using a storage resource (for example, a memory), an interface device (for example, a communication port), or the like. Therefore, a subject of the process performed by executing the program may be the processor. Similarly, the subject of the process performed by executing the program may be a controller, an apparatus, a system, a computer, or a node including the processor. The subject of the process performed by executing the program may be a calculation unit and may include a dedicated circuit that performs a specific process. Here, the dedicated circuit is, for example, a field programmable gate array (FPGA), an application specific integrated circuit (ASIC), or a complex programmable logic device (CPLD).

The program may be installed in the computer from a program source. The program source may be, for example, a program distribution server or a computer-readable storage medium. When the program source is the program distribution server, the program distribution server may include a processor and a storage resource for storing the program to be distributed, and the processor of the program distribution server may distribute the program to be distributed to another computer. In addition, in the embodiment, two or more programs may be implemented as one program, or one program may be implemented as two or more programs.

First, a concept and an outline of a process as a premise of a simulation in the invention will be described.

A simulation apparatus according to the present embodiment is an apparatus that performs a simulation for solving a problem by using an interaction model.

The interaction model is defined by a plurality of nodes constituting the model, a nonlinear coefficient acting between the nodes, and a linear coefficient acting on each node. Here, it is assumed that a variable xᵢ corresponding to each node i (i=1 to N) is a continuous variable xᵢ ∈[−1, 1] or a binary variable xᵢ ∈{−1, 1}. Based on the nonlinear coefficient and the linear coefficient of the interaction model, an energy function H(x) (generally referred to as a Hamiltonian) is defined. In particular, when an interaction relationship is defined between two nodes, the energy function is a quadratic expression represented by the following (Formula 1).

$$H ( x ) = - \frac{1}{2} {x}^{T} J x - {h}^{T} x \qquad ( Formula 1 )$$

Here, J is a square matrix representing a parameter of an interaction between nodes, and h is a vector (also referred to as an external magnetic field) representing a bias to a node.

Generally, the interaction model is expressed as an undirected graph, and a nonlinear term is designated by a set of variables included therein. Therefore, the matrix J is a real symmetric matrix.

The interaction model is a concept including an Ising model. When all variables in the interaction model are limited to the binary variables xᵢ ∈{−1, 1}, the interaction model is an Ising model. The Ising model is used as, for example, a lattice model of a magnetic material in the field of statistical mechanics, and +1 and −1 correspond to up and down directions of a spin.

In the present embodiment, a case where the continuous variable or the binary variable described above corresponds to each node is considered. However, by considering a variable with discrete multiple values or continuous values as each node, a Potts model, an XY model, a Heisenberg model, or the other models that appears in physics can also be considered as the interaction model.

A ground state search of the interaction model is an optimization problem of obtaining a variable array x at which the energy function H(x) is minimized. This is equivalent to a mixed binary quadratic programming problem with interval constraint of variables.

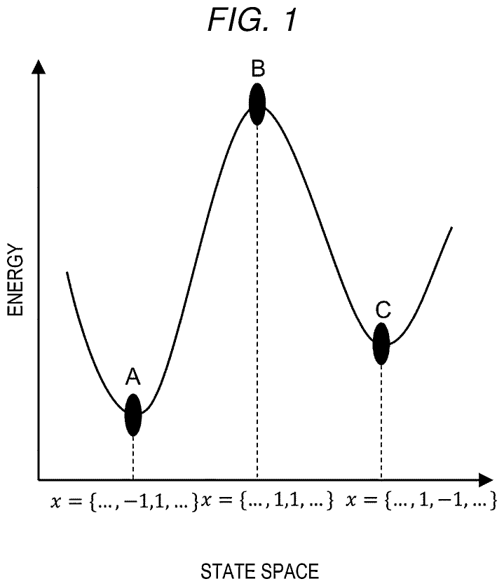

Here, an energy transition of the interaction model, a problem in the related literature, and a relationship between a statistic values of a model in SA process and a temperature parameter will be described by using FIG. 1.

A horizontal axis of a graph represents the variable array, and a vertical axis of the graph represents total energy of a system. In FIG. 1, energy of a state A is the smallest, when a value of a variable of the state A is updated from −1 to 1, a state B with larger energy is obtained, and when a value of a variable of the state B is is updated from 1 to −1, a state C with smaller energy is obtained.

In the present embodiment, the ground state search of the interaction model is performed by using Markov Chain Monte Carlo methods (hereinafter, referred to as MCMC). In a probabilistic transition in the MCMC, a probabilistic transition from a current state x to another state is repeated. Gibbs sampling (also referred to as the heat bath method) is known as a method of sequentially executing probabilistic state transitions.

A probability distribution function of the state x is described by p(x), and a state generated by a α-th Gibbs sampling is described by x^{(α)}={x₁^{(α)}, x_{N}^{(α)}}. At this time, a conditional probability of a (x+1)-th state is generated by sequentially updating a variable having i=1, N as a subscript according to the following (Formula 2).

$${x}_{i}^{( α + 1 )} \sim p ( {x}_{i} \vert {x}_{1}^{( α + 1 )} , … , {x}_{j - 1}^{( α + 1 )} , {x}_{i + 1}^{( α )} , … , {x}_{N}^{( α )} ) \qquad ( Formula 2 )$$

When the MCMC is executed while gradually preventing the transition by introducing a parameter T for controlling the above probabilistic state transition, the state is gradually converged to a ground state. The method using the above procedure for obtaining an optimal solution of a minimization problem of an objective function is simulated annealing.

Hereinafter, a energy transition in a state space when T is gradually changed in the SA will be described.

In response to actual annealing, the parameter T is often referred to as the temperature parameter. The larger the temperature parameter is, the larger randomness of the state transition is, and the smaller the temperature parameter is, the more the state transition behaves like a local search. Hereinafter, a maximum value f the temperature parameter is defined as T_{H}, and a minimum value thereof is defined as T_{L}. As a method of scheduling the temperature parameter in the SA, a commonly used example is the geometric cooling method where the temperature parameter is decreased by geometrically interpolated values from T_{H} to T_{L}.

When the MCMC or the SA is applied to the interaction model, the value of the variable is probabilistically updated based on (Formula 2) or the like. Here, variables that do not have a nonlinear term therebetween are independent of each other in an energy function expression and thus a probabilistic distribution function, and the probabilistic state transition based on (Formula 2) can be simultaneously applied. Therefore, by updating independent variables in parallel, it is possible to speed up the process in the MCMC and the SA.

Such speeding up can be performed using an interaction model in which the interaction relationship has a bipartite graph structure, that is, no interaction relationship is present in each subgraph. For example, in PTL 1, a method of efficiently obtaining a ground state of a fully coupled interaction model is proposed by solving a ground state search problem of an interaction model with a complete bipartite graph structure after relaxing all binary variables into continuous values.

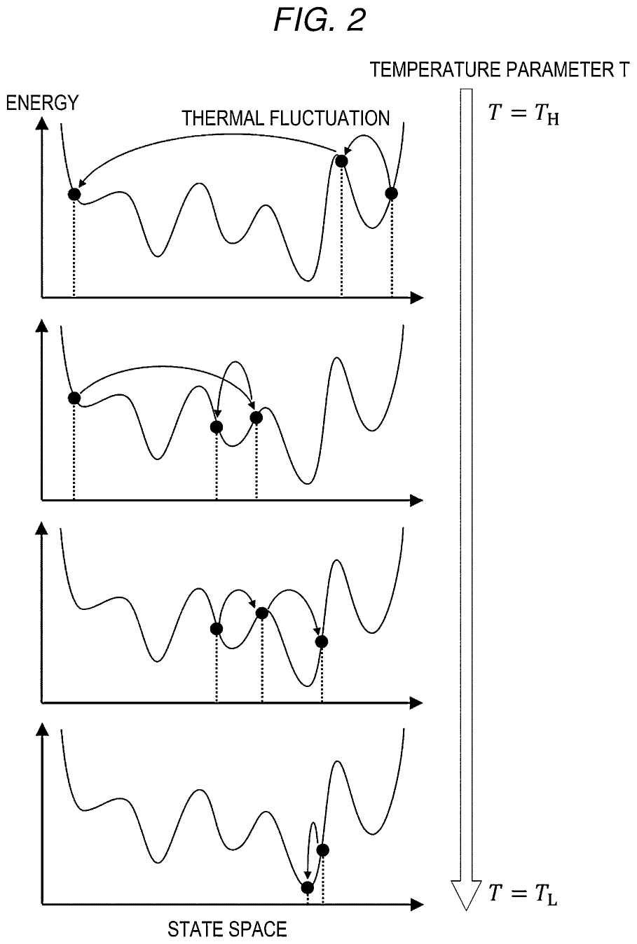

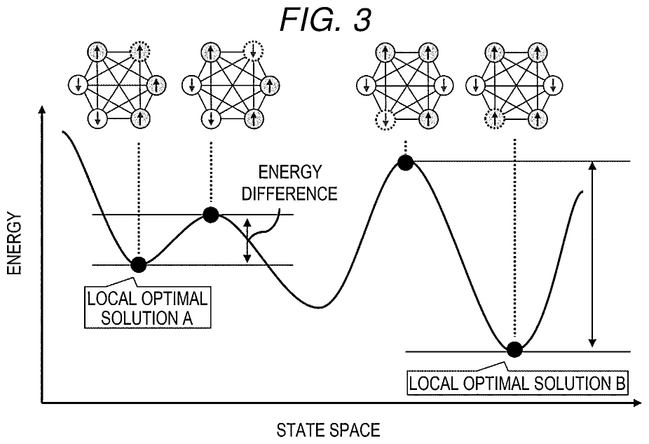

As shown in an energy transition diagram in FIG. 2, in order for the temperature parameter to determine a method of searching for a state space, it is important to appropriately set the temperature parameter in order to maximize performance of the SA. PTL 2 discloses a method of determining an appropriate T_{H} for an Ising model including binary variables. FIG. 3 is a diagram showing a change in the ground state and the energy transition in the method. When T=T_{H}, it is desirable for the state search to transition to another state without remaining at a local optimal solution. Therefore, in the technique described in PTL 2, it is proposed to first obtain the local optimal solution, then calculate an energy difference between it and the spin-flipped state, and set the temperature parameter to T_{H} such that the state transition can exceed the energy.

However, in an interaction model including a variable (for example, a continuous variable as handled in PTL 1) having a plurality of next state candidates, a plurality of candidates for referring to the energy difference as shown in FIG. 3 appear, and it is impossible to estimate a more appropriate temperature parameter by the method in PTL 2.

In view of such a background, a simulation method according to the present embodiment determines, in simulated annealing for an interaction model having variables taking discrete multiple values or continuous values, a temperature parameter suitable for the simulated annealing by referring to information on a local optimal solution and a statistic of a probability distribution function of a variable.

Here, a case of a diagonal element Jᵢᵢ>0 in the energy function represented by Formula 1 is exemplified. However, when the variable xᵢ is a binary variable {−1, +1}, a term including Jᵢᵢ is a constant as Jᵢᵢxᵢ²=Jᵢᵢ, and thus contribution thereof can be ignored.

In the simulation, the state is transitioned according to the Gibbs sampling. By performing the state update a sufficient number of times, the state {x} of the interaction model on a right side of (Formula 1) appears with the probability distribution function p(x) based on a Boltzmann distribution represented by the following (Formula 3).

$$p ( x ) = \frac{1}{Z} exp ( - \frac{H ( X )}{T} ) \qquad ( Formula 3 )$$

Here, Z is a normalization factor of the Boltzmann distribution called the partition function. By applying the Gibbs sampling shown in (Formula 2) to the Boltzmann distribution, x can be probabilistically updated.

Hereinafter, a process of setting a temperature parameter appropriate for the simulated annealing according to the information of the local optimal solution and the statistic of the probability distribution function of the variable will be described.

For this purpose, a vector g represented by the following (Formula 4) is defined. The vector g is related to a quantity obtained by differentiating, by x, the energy function H(x) represented by (Formula 1).

$$g = J x + h \qquad ( Formula 4 )$$

Here, each variable xᵢ appears according to the probability distribution function represented by (Formula 3), and a standard deviation is considered as an indicator for evaluating a degree of variation of the variable value. By representing an average value of a certain amount · under the probability distribution function p(x) as E[·], a standard deviation SD[xᵢ] is generally represented by the following (Formula 5).

$$SD [ {x}_{i} ] = \sqrt{E [ {x}_{i}^{2} ] - {E [ {x}_{i} ]}^{2}} \qquad ( Formula 5 )$$

First, a case where the variable xᵢ is a binary variable will be described.

Based on (Formula 3), the probability distribution function of the variable xᵢ∈{−1, +1} follows a discrete probability distribution function represented by the following (Formula 6).

$$p ( {x}_{i} ) = exp ( - \frac{{g}_{i} {x}_{i}}{T} ) / ( exp ( - \frac{{g}_{i}}{T} ) + exp ( \frac{{g}_{i}}{T} ) ) \qquad ( Formula 6 )$$

When the standard deviation is calculated according to (Formula 5) for the probability distribution function represented by (Formula 6), the following (Formula 7) is obtained.

$$SD [ {x}_{i} ] = sech ( {g}_{i} / T ) \qquad ( Formula 7 )$$

Here, “sech(·)” is the hyperbolic secant function.

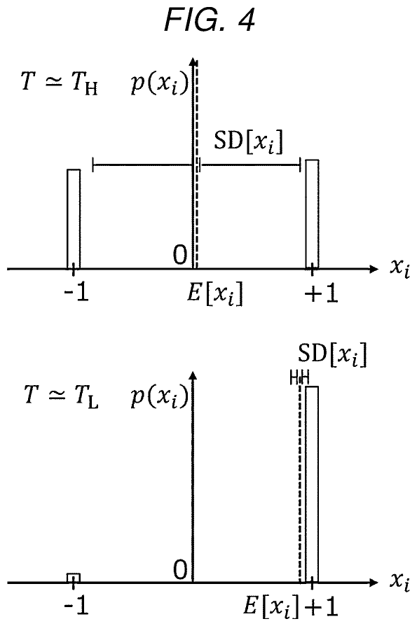

FIG. 4 shows a state of a discrete probability distribution function of a binary variable according to a value taken by the temperature parameter.

When the temperature parameter is large (|gᵢ/T|<<1), −1 and +1 appear with almost the same probability. At this time, an average value E[xᵢ] of the variable xᵢ is almost 0, and the standard deviation SD[xᵢ] thereof is almost 1.

On the other hand, when the temperature parameter is small (|gᵢ/T|>>1), the variable value is localized at −1 or +1 according to the sign of gᵢ. At this time, the average value E[xᵢ] of the variable xᵢ approaches a localized value, and the standard deviation SD[xᵢ] thereof is almost 0.

Next, a case where the variable xᵢ is a continuous variable will be described.

Based on (Formula 3), the variable xᵢ follows a continuous probability distribution function represented by the following (Formula 8).

$$p ( {x}_{i} ) ∝ exp ( - \frac{{J}_{ii}}{2 T} {( {x}_{i} - {g}_{i} / {J}_{ii} )}^{2} ) = exp ( - \frac{( {x}_{i} - μ )}{2 {σ}^{2}} ) \qquad ( Formula 8 )$$

This probability distribution function is a truncated normal distribution having an average value μ=gᵢ/Jᵢᵢ and a variance σ²=T/Jᵢᵢ defined on a closed interval [−1, +1].

Then, by representing (a, b)=((−1−μ)/σ, (1−μ)/σ), auxiliary variables indicating a range are replaced as shown in the following (Formula 9).

$$( α , β ) = \{ \begin{matrix}( a , b ) & ( \vert a \vert ≦ \vert b \vert ) \\ ( - b , - a ) & ( \vert a \vert > \vert b \vert )\end{matrix} \qquad ( Formula 9 )$$

Accordingly, the standard deviation SD[xᵢ] is represented by the following (Formula 10).

$$( Formula 10 )$$

$$SD [ {x}_{i} ] = \sqrt{1 - \frac{{e}^{- {β}^{2}} β - {e}^{- {α}^{2}} α}{\sqrt{\frac{π}{2}} ( erf ( \frac{β}{\sqrt{2}} ) - erf ( \frac{α}{\sqrt{2}} ) )} - {( \frac{{e}^{- {β}^{2}} - {e}^{- {α}^{2}}}{\sqrt{\frac{π}{2}} ( erf ( \frac{β}{\sqrt{2}} ) - erf ( \frac{α}{\sqrt{2}} ) )} )}^{2}}$$

Here, erf(·) is the error function.

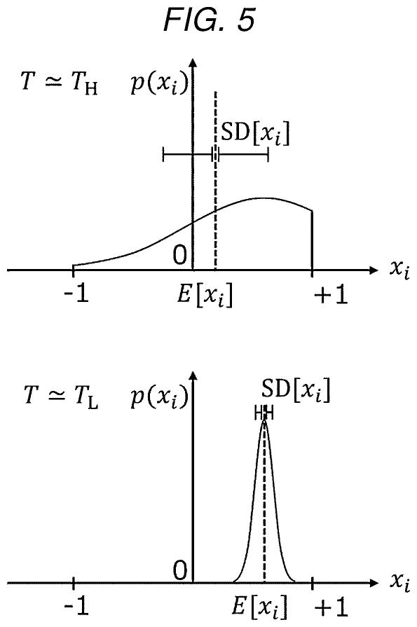

FIG. 5 shows a state of a continuous probability distribution function of the continuous variable according to a value of the temperature parameter.

When the temperature parameter is large, the truncated normal distribution approaches a uniform distribution, the average value E[xᵢ] of the variable xᵢ approaches 0, and the standard deviation SD[xᵢ] thereof approaches 1/√3.

On the other hand, when the temperature parameter is small, the variable xᵢ is localized at sign (gᵢ/Jᵢᵢ) in a case of |gᵢ/Jᵢᵢ|≥1, and the variable xᵢ is localized at (gᵢ/Jᵢᵢ) in the case of |gᵢ/Jᵢᵢ|<1, and thus, the standard deviation SD[xᵢ] is almost 0. Here, sign (·) is the sign function that returns a sign of an argument ·.

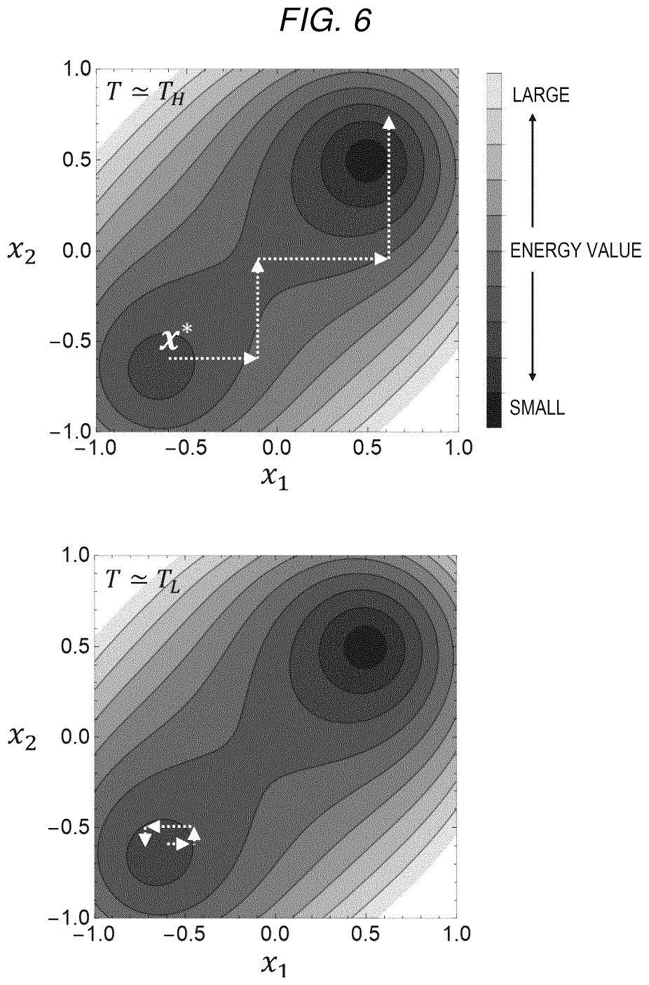

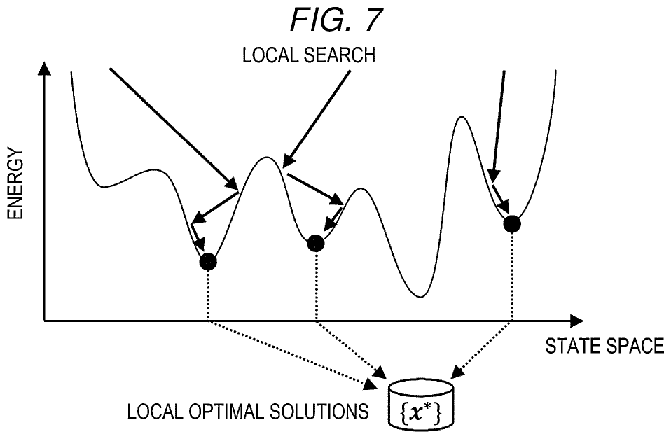

Based on the above, a method of considering the setting of the temperature parameter range in the SA according to the present embodiment will be described with reference to FIGS. 6 and 7.

By using the inverse function method or the rejection sampling method for the interaction model following the probability distribution functions represented by (Formula 6) and (Formula 8), the next state can be randomly sampled from the distribution functions.

FIG. 6 is a diagram showing how to move a state space by repeating random sampling on the next state according to (Formula 8) when variables x₁, x₂ are continuous variables. When the temperature parameter is large (upper portion in FIG. 6), the state largely moves regardless of the energy value of the interaction model. On the other hand, when the temperature parameter is small (lower portion in FIG. 6), the energy value remains around a specific local optimal solution.

FIG. 6 shows that the darker a color of a position of a state, the lower (more stable) the energy of the interaction model. A trajectory x⁺ is a search route for a value as the local optimal solution. The upper portion in FIG. 6 shows a situation where the temperature parameter is large, and the lower portion in FIG. 6 shows a situation where the temperature parameter is small.

When T=T_{H} immediately after the start of the SA, it is desirable that the state not only remains the local optimal solution but also moves to various states. This corresponds to a situation where spread of the probability distribution of the variable, for example, the standard deviation is close to 1 to some extent, as shown in FIGS. 4 and 5.

On the other hand, when T=T_{L} just before the end of the SA, it is desirable that the current state converges to an optimal solution with almost no state transition. This corresponds to a situation where spread of the probability distribution of the variable, for example, the standard deviation is close to 0 to some extent, as shown in FIGS. 4 and 5.

Therefore, in the present embodiment, the aim is to be able to execute the SA with an appropriate temperature parameter by determining the maximum value T_{H} and the minimum value T_{L} of the temperature parameter range in the following procedure. In the following, θ_{H} and θ_{L} are respectively thresholds for the standard deviation when determining the maximum value and the minimum value of the temperature parameter.

First, as shown in FIG. 7, a plurality of local optimal solutions are generated by a local search method or the SA in which the number of steps of MCMC is reduced.

Subsequently, the spread of the distribution of the variables xᵢ included in the local optimal solutions and the standard deviation SD[xᵢ] are calculated. Then, if the temperature at which SD[xᵢ]>θ_{H} holds for all SD[xᵢ] is T=T_{H}, all variables do not stay at the local optimal solutions and the state changes in the temperature range. If the temperature at which SD[xᵢ]≤θ_{L} holds for all SD[xᵢ] is T=T_{L}, all variables hardly move from the local optimal solutions in the temperature region, and the search ends.

When there are a plurality of temperatures at which SD[xᵢ]=OH holds for all SD[xᵢ], the largest value thereof is set as a maximum value of a range in which the next SA is performed.

On the other hand, when there are a plurality of temperatures at which SD[xᵢ]=θ_{L} holds for all SD[xᵢ], the smallest value thereof is set as a minimum value of the range in which the next SA is performed.

In the above, all SD[xᵢ] are considered. However, when SD[xᵢ] corresponding to some variables are extremely large or small, such outliers of SD[xᵢ] can be excluded.

In the above, the maximum value T_{H} and the minimum value T_{L} of the temperature parameter for performing the next SA are determined based on the standard deviation of the variables xᵢ as the statistics. In addition, T_{H} and T_{L} may be calculated using statistics such as an expected value of an absolute difference between xᵢ before and after applying the state update to the local optimal solution.

In addition, instead of the absolute difference of xᵢ before and after a single state update, T_{H} may be determined such that a sum of moving distances within a predetermined number of times of the search of the optimal solution as shown in FIG. 6 is greater than a certain threshold, and T_{L} may be determined such that the sum of the moving distances within a predetermined number of times of the search of the local optimal solution is smaller than a certain threshold.

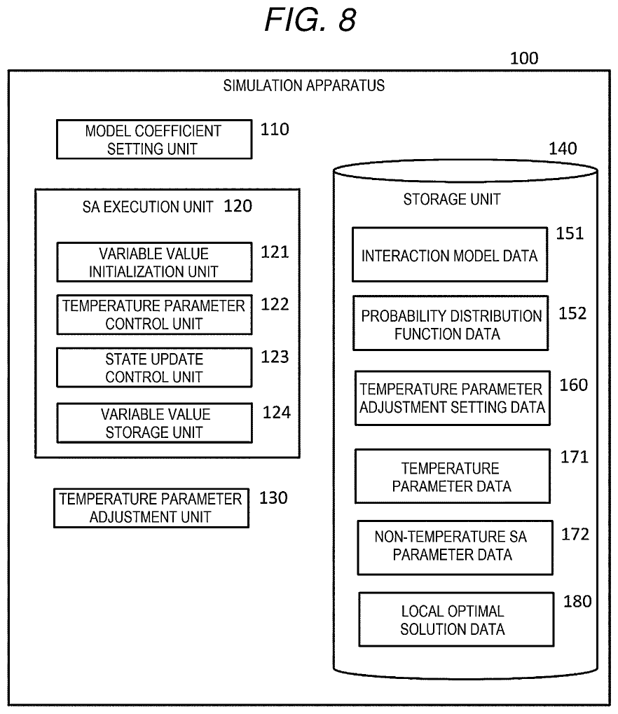

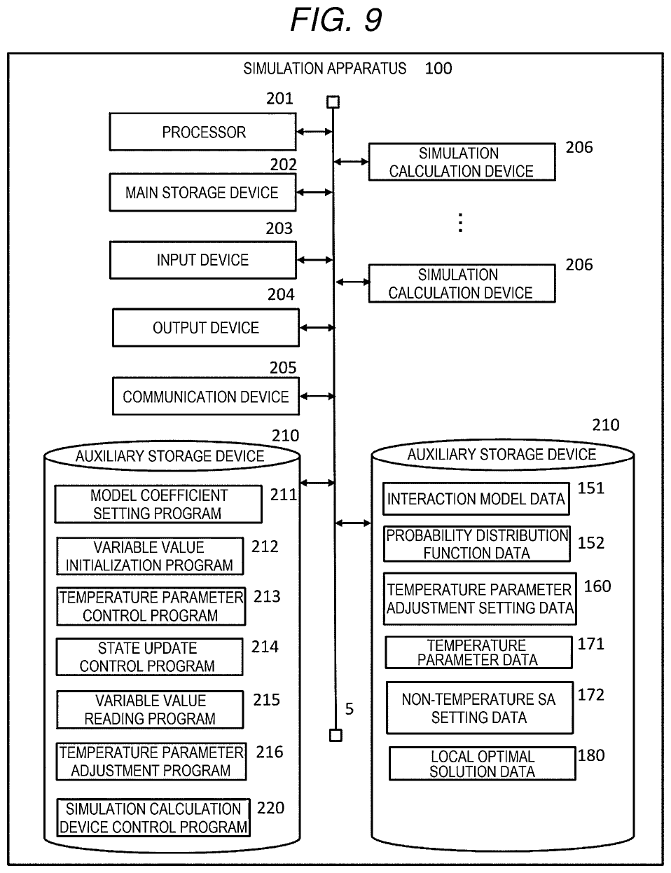

Next, a configuration of the simulation apparatus and a data flow in a simulation according to the present embodiment will be described with reference to FIGS. 8 and 9.

First, a functional configuration of the simulation apparatus will be described with reference to FIG. 8.

As shown in FIG. 8, a simulation apparatus 100 according to the present embodiment includes, as a functional configuration, a model coefficient setting unit 110, an SA execution unit 120, a temperature parameter adjustment unit 130, and a storage unit 140.

The model coefficient setting unit 110 is a functional unit that sets a coefficient such as a Hamiltonian representing a model based on interaction model data 151 (described later).

The SA execution unit 120 is a functional unit that performs a calculation in the SA.

The SA execution unit 120 includes, as sub functional units, a variable value initialization unit 121, a temperature parameter control unit 122, a state update control unit 123, and a variable value storage unit 124.

The variable value initialization unit 121 is a functional unit that initializes a variable (such as a state value of each node of the interaction model) used in a simulation.

The temperature parameter control unit 122 is a functional unit that controls the temperature parameter T in the SA.

The state update control unit 123 is a functional unit that executes a calculation related to a state update according to the SA for the interaction model.

The variable value storage unit 124 is a functional unit that, when the SA is completed, reads a variable value corresponding to an optimal solution and stores the read value in an auxiliary storage device 210.

The temperature parameter adjustment unit 130 is a functional unit that calculates the maximum value T_{H} and the minimum value T_{L} of the search range for the temperature parameter based on information on a local optimal solution.

The storage unit 140 is a functional unit that stores data used in the simulation apparatus 100.

The storage unit 140 stores the interaction model data 151, probability distribution function data 152, temperature parameter adjustment setting data 160, temperature parameter data 171, non-temperature SA setting data 172, and local optimal solution data 180. Details of each piece data will be described later.

Next, a hardware and software configuration of the simulation apparatus will be described with reference to FIG. 9.

The simulation apparatus 100 has a configuration in which a processor 201, a main storage device 202, the auxiliary storage device 210, an input device 203, an output device 204, a communication device 205, and one or more simulation calculation devices 206 are connected by a system bus 5.

The simulation apparatus 100 may be a general information processing apparatus such as a PC, or may be partially or entirely implemented using a virtual information processing resource such as a cloud server provided by a cloud system. The simulation apparatus 100 may be implemented by, for example, a plurality of information processing apparatuses that operate in cooperation with one another and are communicably connected to one another.

The processor 201 is, for example, a central processing unit (CPU) or a micro processing unit (MPU), controls the entire simulation apparatus 100, refers to data in the main storage device 202, and executes a program loaded in the main storage device 202.

The main storage device 202 is a volatile storage device that stores programs and data, and is a semiconductor storage device such as a dynamic random access memory (DRAM).

The input device 203 is a device for receiving an input of information from a user, and is, for example, a keyboard, a mouse, a card reader, or a touch panel.

The output device 204 is a device for outputting information to a user, and is, for example, a display device (liquid crystal display (LCD), a graphic card, or the like) that visualizes various types of information, an audio output device (speaker), or a printing device.

The communication device 205 is a communication interface device that communicates with other devices, and is, for example, a network interface card (NIC), a wireless communication module, a universal serial interface (USB) module, or a serial communication module.

The simulation calculation device 206 is a device that performs a simulation calculation for executing the ground state search. The simulation calculation device 206 may take a form of an expansion card attached to the simulation apparatus 100, such as a graphics processing unit (GPU). The simulation calculation device 206 is implemented by hardware such as a complementary metal oxide semiconductor (CMOS) circuit, a field programmable gate array (FPGA), or an application specific integrated circuit (ASIC). The simulation calculation device 206 includes a control device, a storage device, an interface for connecting to the system bus 5, and the like, and transmits and receives commands and information to and from the processor 201 via the system bus 5. For example, the simulation calculation device 206 may be communicably connected to another simulation calculation device 206 via a communication line and operate in cooperation with the another simulation calculation device 206. Functions implemented by the simulation calculation device 206 may be implemented by, for example, causing the processor 201 to execute a program.

The auxiliary storage device 210 is a nonvolatile large-capacity storage device such as a hard disk drive or a solid state drive (SSD). The programs and data stored in the auxiliary storage device 210 are read into the main storage device 202 as needed.

A model coefficient setting program 211, a variable value initialization program 212, a temperature parameter control program 213, a state update control program 214, a variable value reading program 215, a temperature parameter adjustment program 216, and a simulation calculation device control program 220 are installed in the auxiliary storage device 210.

The model coefficient setting program 211, the variable value initialization program 212, the temperature parameter control program 213, the state update control program 214, the variable value reading program 215, and the temperature parameter adjustment program 216 are programs that execute the functions of the model coefficient setting unit 110, the variable value initialization unit 121, the temperature parameter control unit 122, the state update control unit 123, the variable value storage unit 124, and the temperature parameter adjustment unit 130, respectively.

The simulation calculation device control program 220 is a program for the processor 201 to control the simulation calculation device 206.

In addition to the above programs, programs such as an operating system, a file system, a device driver, and a data base management system (DBMS) are installed in the auxiliary storage device 210 of the simulation apparatus 100, but are omitted in FIG. 9.

The auxiliary storage device 210 stores the interaction model data 151, the probability distribution function data 152, the temperature parameter adjustment setting data 160, the temperature parameter data 171, the non-temperature SA setting data 172, and the local optimal solution data 180.

In addition, as the auxiliary storage device 210, an optical storage device (compact disc (CD), digital versatile disc (DVD), or the like) may be connected, and external data can be read and stored.

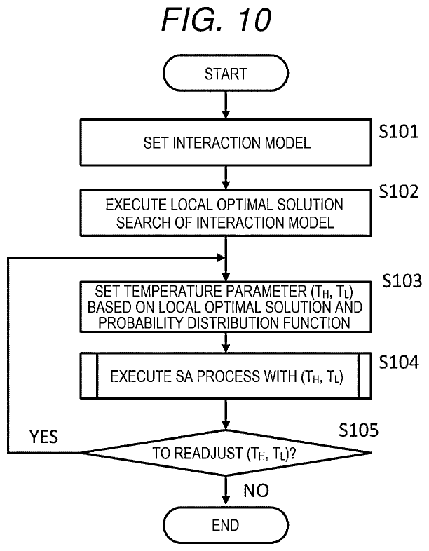

Next, a process performed by the simulation apparatus according to the present embodiment will be described with reference to FIGS. 10 to 12.

A ground state search process shown in FIG. 10 is a process performed by the simulation apparatus 100 to implement the ground state search of the interaction model by the SA.

The ground state search process is started by, for example, receiving an instruction or the like from the user via the input device 203.

First, the model coefficient setting unit 110 sets information on model coefficients in the simulation calculation device 206 (S101). Values thereof can be set or edited by the user via, for example, the input device 203.

Next, the variable value initialization unit 121 initializes variable values of the simulation calculation device 206, and acquires information on a local optimal solution according to an instruction of the temperature parameter adjustment unit 130 (S102). Further, T_{H} and T_{L} are determined according to the acquired local optimal solution and information on a probability distribution function of the variable used in the SA (S103).

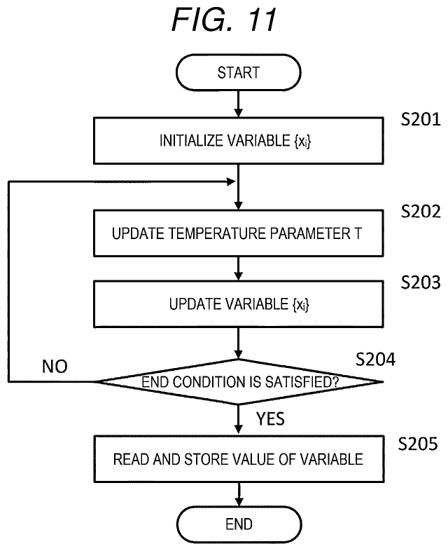

Next, if necessary, the variable value initialization unit 121 initializes the variable values of the simulation calculation device 206 again, and the temperature parameter control unit 122 and the state update control unit 123 give instructions to the simulation calculation device 206 to execute an SA process (S104). Details of the SA process will be described later with reference to FIG. 11.

Next, the temperature parameter adjustment unit 130 determines whether readjustment of the temperature parameter range (T_{H} and T_{L}) is necessary (S105), and when it is determined that the readjustment is necessary (S105: YES), the process returns to S103, and when it is determined that the readjustment is not necessary (S105: NO), the process ends.

For example, the temperature parameter adjustment unit 130 compares the values of T_{H} and T_{L} calculated based on the previously acquired local optimal solutions with the values of T_{H} and T_{L} calculated by adding information on a newly acquired local optimal solution, and requests the calculation in the SA again when there is a change.

Next, the SA process performed by the simulation apparatus will be described with reference to FIG. 11.

The SA process is a process corresponding to S104 in FIG. 10.

First, the variable value initialization unit 121 initializes the variable values of the simulation calculation device 206 (S201). For example, as an initial variable value, any value of {−1, +1} is adopted at a probability of 50% for the binary variable, and a value is adopted by random sampling from a uniform distribution in an interval of [−1, +1] for the continuous variable.

Next, the temperature parameter control unit 122 updates the temperature parameter of the simulation calculation device 206 (S202). In the first update, the maximum value T_{H} of the temperature parameter is set. In a subsequent update, the temperature parameter is updated to the minimum value T_{L} of the temperature parameter according to the above-described geometric cooling method or the like.

The state update control unit 123 updates a state of the variable by the random sampling based on the probability distribution functions represented by (Formula 6) and (Formula 8) (S203). This process is performed in order from 1 to N for the subscript i of the variable xᵢ, or is implemented in random order for the subscript i from 1 to N.

Next, the state update control unit 123 determines whether an SA end condition is satisfied (for example, whether the state update is executed while changing the temperature parameter T a predetermined number of times) (S204). When it is determined that the SA end condition is satisfied (S204: YES), the process proceeds to S205. On the other hand, when it is determined that the SA end condition is not satisfied (S204: NO), the process returns to S202.

Next, the variable value storage unit 124 reads the value stored in a variable memory, stores the value in the auxiliary storage device 210 as a result of the ground state search (S205), and ends the process.

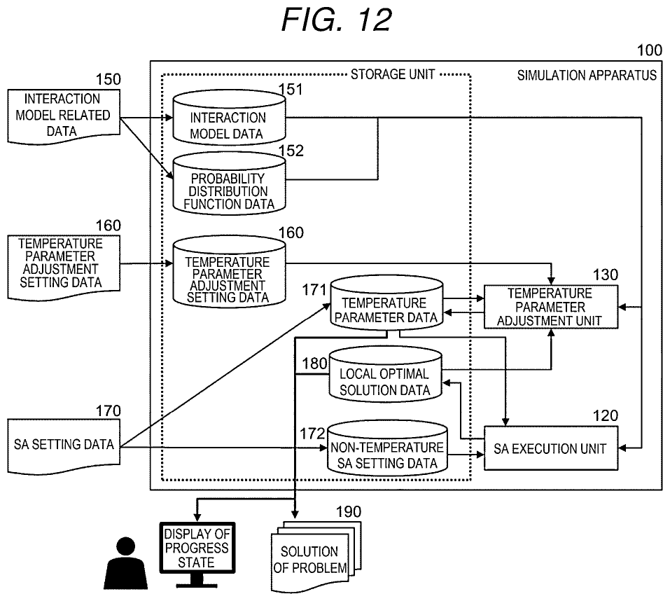

Next, the data flow in the simulation apparatus will be described with reference to FIG. 12.

In FIG. 12, regarding a functional configuration, only main portions in association with data are shown.

The simulation apparatus 100 receives interaction model related data 150, the temperature parameter adjustment setting data 160, and SA setting data 170 from the user, and executes a series of simulation processes.

The interaction model data 151 and the probability distribution function data 152 are stored based on the interaction model related data 150 from the user. The interaction model data 151 is data related to the values of J and h in (Formula 1) and the types of variables (binary variable/continuous variable). The probability distribution function data 152 is data designating a probability distribution function of the state of the interaction model, such as the Boltzmann distribution represented by (Formula 3). In the above-described embodiment, the probability distribution functions represented by (Formula 6) and (Formula 8) are set by combining (Formula 1) corresponding to the interaction model data 151 and (Formula 3) corresponding to the probability distribution function data 152.

The temperature parameter adjustment setting data 160 is data related to a method for estimating T_{H} and T_{L} based on the local optimal solution described in the setting of the temperature parameter range. For example, when the local optimal solution is searched by the SA, the thresholds (θ_{H}, θ_{L}) for determining the temperature parameter range are given as hyper parameters, and the determination condition or the like in S105 of FIG. 10 is also given by the setting data. The temperature parameter adjustment setting data 160 is input to the temperature parameter adjustment unit 130.

The temperature parameter adjustment unit 130 updates the temperature parameter data 171 based on the local optimal solution data 180.

The SA setting data 170 is stored as the temperature parameter data 171 and the non-temperature SA setting data 172. The temperature parameter data 171 is data representing T in (Formula 6) or (Formula 8). The non-temperature SA setting data 172 is data related to the number of times of variable update and the method of updating the temperature parameter, and is input to the SA execution unit 120.

The SA execution unit 120 performs the SA based on the temperature parameter data 171 and the non-temperature SA setting data 172, and updates the local optimal solution data 180.

The simulation apparatus 100 can sequentially output the temperature parameter data 171 and the local optimal solution data 180 in the middle of the process shown in FIG. 10 to display the process of determining an appropriate temperature to the user, and thus the user can grasp the temperature parameter substantially appropriate for the problem and a provisional solution of the problem before the end of the search.

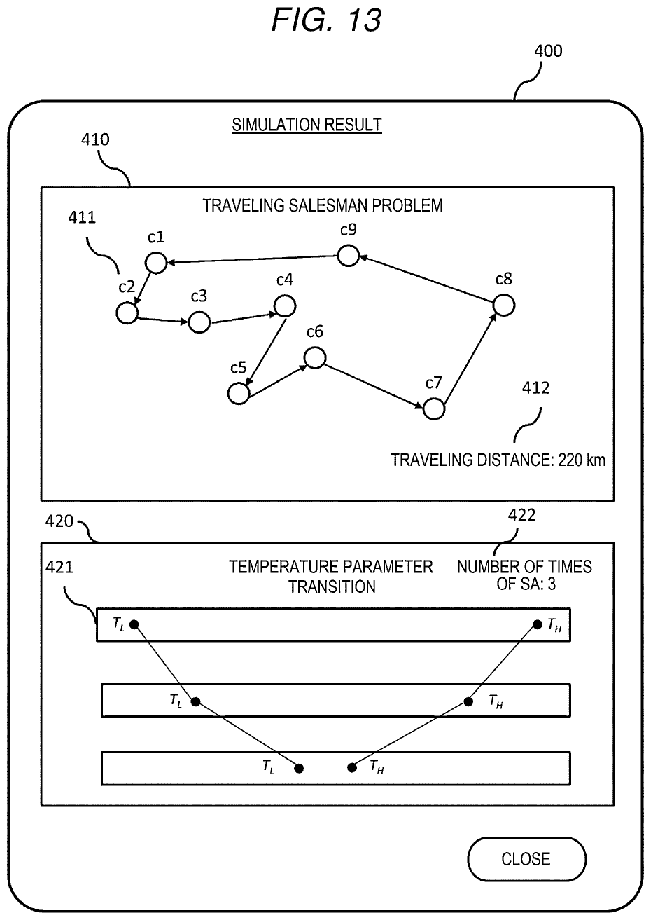

Next, a user interface provided by the simulation apparatus will be described with reference to FIG. 13.

Hereinafter, a user interface in a case where the SA according to the present embodiment is applied to a traveling salesman problem will be described. The traveling salesman problem is a problem in which a set of cities and distances between the cities are given, and the shortest route is obtained among routes (traveling routes) along which a salesman visits all cities just once and then returns to a starting city.

A simulation result screen 400 includes an optimal solution display region 410 and a temperature parameter display region 420.

In the optimal solution display region 410, a graph 411 indicating an order of places visited by the salesman and a total sum 412 of the travelling distances are displayed.

In the temperature parameter display region 420, the number of times of the SA 422 and a temperature parameter search range transition 421 are displayed.

As described above, according to the simulation apparatus of the present embodiment, it is possible to appropriately determine the temperature parameter range for performing the ground state search of the interaction model by the simulated annealing based on the statistics of the local optimal solutions that are already obtained, and it is possible to efficiently execute a search with a better solution.

What is claimed is:

1. A simulation apparatus that obtains a solution of a certain combinatorial optimization problem by simulated annealing, wherein
a local optimal solution of an objective function of the problem is acquired by using a local search method of changing a temperature parameter,
a statistic is calculated based on the local optimal solution and a probability distribution function of a variable included in the objective function,
a maximum value and a minimum value as a search range for the temperature parameter are obtained based on the calculated statistic, and
the solution is obtained by executing the simulated annealing a plurality of times in the search range having the maximum value and the minimum value for the temperature parameter.

2. The simulation apparatus according to claim 1, wherein
the statistic is a standard deviation of the variable when a state update is performed with respect to a state of the local optimal solution and an expected value of a moving distance when the state update is performed a predetermined number of times.

3. The simulation apparatus according to claim 1, wherein
the statistic is a standard deviation of the variable when a state update is performed with respect to a state of the local optimal solution, a temperature when the standard deviation is larger than a predetermined threshold is set as the maximum value of the search range for the temperature parameter, and a temperature when the standard deviation is smaller than the predetermined threshold is set as the minimum value of the search range for the temperature parameter.

4. The simulation apparatus according to claim 1, wherein
the objective function is a function describing a state of an interaction model including a plurality of nodes.

5. The simulation apparatus according to claim 1, wherein
the objective function is an energy function, and
the local optimal solution is obtained as a state where energy of the energy function is minimized.

6. The simulation apparatus according to claim 1, wherein
a ground state search using the simulated annealing is performed by transitioning a state using a probability distribution function including the temperature parameter as a variable.

7. The simulation apparatus according to claim 6, wherein
the probability distribution function is a function based on a Boltzmann distribution.

8. The simulation apparatus according to claim 6, wherein
the state is transitioned by using a Markov Chain Monte Carlo method.

9. The simulation apparatus according to claim 1, wherein
the variable is a binary variable or a continuous variable.

10. A simulation method performed by using a simulation apparatus that obtains a solution of a certain combinatorial optimization problem by simulated annealing, the simulation method comprising:
a step of the simulation apparatus acquiring a local optimal solution of an objective function by using a local search method of changing a temperature parameter;
a step of the simulation apparatus calculating a statistic based on the local optimal solution and a probability distribution function of a variable included in the objective function;
a step of the simulation apparatus obtaining a maximum value and a minimum value as a search range for the temperature parameter based on the calculated statistic; and
a step of the simulation apparatus obtaining the solution by executing the simulated annealing a plurality of times in the search range having the maximum value and the minimum value for the temperature parameter, wherein
in the simulation apparatus, the statistic is a standard deviation related to a state of the local optimal solution, and a temperature when the standard deviation related to the state of the local optimal solution is larger than a predetermined threshold is set as the maximum value of the search range for the temperature parameter, and a temperature when the standard deviation related to the state of the local optimal solution is smaller than the predetermined threshold is set as the minimum value of the search range for the temperature parameter.
